(19) United States
(12) Patent Application Publication
(10) Pub. No.: US 2026/0227067 A1
(43) Pub. Date: Aug. 6, 2026

(54) BURNER ASSEMBLY, GAS TURBINE COMBUSTOR, AND GAS TURBINE

(71) Applicant: MITSUBISHI HEAVY INDUSTRIES, LTD., Tokyo (JP)

(72) Inventors: Shinichi FUKUBA, Tokyo (JP); Keisuke MIURA, Tokyo (JP); Zhi ZHANG, Tokyo (JP); Masashi KITAMURA, Tokyo (JP); Tomoya NAKAYAMA, Tokyo (JP)

(73) Assignee: MITSUBISHI HEAVY INDUSTRIES, LTD., Tokyo (JP)

(21) Appl. No.: 19/142,408

(22) PCT Filed: Sep. 21, 2023
(86) PCT No.: PCT/JP2023/034280

§ 371 Date: Jun. 23, 2025

(30) Foreign Application Priority Data
Mar. 29, 2023 (JP) 2023-053414

(51) Int. Cl. F23R 3/28; F23R 3/44

(52) U.S. Cl. CPC F23R 3/28; F23R 3/44

(57) ABSTRACT

This burner assembly is provided with a plurality of burners for mixing fuel and air. Each of the plurality of burners comprises a mixing flow path into which air is supplied, and a fuel nozzle that extends along the central axis of the mixing flow path inside the mixing flow path and is configured to inject fuel. The fuel nozzle includes an orifice upstream of the outlet of the fuel nozzle.

### TECHNICAL FIELD

The present disclosure relates to a burner assembly, a gas turbine combustor, and a gas turbine.

The present application claims priority based on Japanese Patent Application No. 2023-053414 filed in the Japan Patent Office on Mar. 29, 2023, the contents of which are incorporated herein by reference.

### BACKGROUND ART

As a technique for reducing NOx while having flashback resistance for fuel (for example, hydrogen or the like) having a high risk of flashback, there is a technique that forms a large number of independent small flames using a burner assembly (cluster burner).

In this technique, a plurality of mixing flow paths for mixing fuel and air are disposed, and the scale of fuel mixing is reduced, which makes it possible to obtain high mixing performance without actively using a swirl flow for mixing the fuel and the air.

A burner described in PTL 1 is configured such that a fuel nozzle injects fuel along a central axis of a mixing flow path, and a central axis of the fuel nozzle is matched with the central axis of the mixing flow path. Therefore, the burner may be referred to as a coaxial type. In the case of this coaxial burner, the concentration of fuel in the vicinity of a wall surface of the mixing flow path is less likely to be higher than that in the case of a crossflow burner that injects fuel in a direction intersecting with the flow of air from a flow path wall of the mixing flow path. Therefore, it is possible to suppress the risk of flashback (backfire).

A burner assembly described in PTL 2 includes a plurality of burners for mixing fuel and air, and each of the plurality of burners includes a fuel nozzle, a mixing flow path to which the fuel and the air are supplied, and a support portion that connects a flow path wall of the mixing flow path and the fuel nozzle and supports the fuel nozzle. According to this configuration, since the fuel nozzle is supported by the support portion connected to the flow path wall of the mixing flow path in each of the burners, it is not necessary to provide a large header described in PTL 1 that is provided independently of the flow path wall of the mixing flow path on an upstream side of the mixing flow path. Therefore, it is possible to eliminate a bias in the flow rate of air between a plurality of mixing flow paths caused by the header and to reduce a bias in the fuel concentration between the plurality of mixing flow paths. Therefore, it is possible to reduce NOx and to suppress flashback.

### CITATION LIST

### Patent Literature

[PTL 1] Japanese Unexamined Patent Application Publication No. 2007-232234.

[PTL 2] Japanese Unexamined Patent Application Publication No. 2021-173190.

### SUMMARY OF INVENTION

### Technical Problem

At least one embodiment of the present disclosure is a further improvement of the related art described in PTL 2, and an object thereof is to provide a burner assembly that can suppress flashback, and a gas turbine combustor and a gas turbine including the burner assembly.

### Solution to Problem

In order to achieve the above object, according to at least one embodiment of the present disclosure, there is provided a burner assembly including a plurality of burners for mixing fuel and air, in which each of the plurality of burners includes a mixing flow path to which the air is supplied and a fuel nozzle that extends along a central axis of the mixing flow path inside the mixing flow path and is configured to inject the fuel, and the fuel nozzle includes an orifice provided on an upstream side of an outlet of the fuel nozzle.

In order to achieve the above object, according to at least one embodiment of the present disclosure, there is provided a gas turbine combustor including: the above-described burner assembly; and a combustion cylinder that forms a space, in which a flame is formed, on a downstream side of the burner assembly.

In order to achieve the above object, according to at least one embodiment of the present disclosure, there is provided a gas turbine including: a compressor; a gas turbine combustor that is configured to be supplied with air compressed by the compressor and fuel and to combust the fuel to generate combustion gas; and a turbine that is driven by the combustion gas generated by the gas turbine combustor, in which the gas turbine combustor is the above-described gas turbine combustor.

### Advantageous Effects of Invention

According to at least one embodiment of the present disclosure, a burner assembly that can suppress flashback and a gas turbine combustor and a gas turbine including the burner assembly are provided.

### BRIEF DESCRIPTION OF DRAWINGS

FIG. 1 is a schematic configuration diagram showing a gas turbine 100 according to an embodiment.

FIG. 2 is a schematic cross-sectional view showing the vicinity of a combustor 4 shown in FIG. 1.

FIG. 3 is a schematic cross-sectional view taken along a central axis G of a burner assembly 32 according to the embodiment.

FIG. 4 is a schematic cross-sectional view showing an example of a schematic configuration of a burner 42 shown in FIG. 3.

FIG. 5 is an enlarged schematic cross-sectional view showing the vicinity of an outlet 49 of a mixing flow path 46 shown in FIG. 4.

FIG. 6 is a schematic cross-sectional view showing the vicinity of an outlet 060 of a fuel nozzle 043 in a mixing flow path 046 according to a comparative example.

FIG. 7A is a diagram showing an example of a distribution of an axial-direction flow speed of fuel and air in a case where the orifice 62 is formed as designed to inject the fuel along a central axis O for the mixing flow path 46 of the burner 42 shown in FIG. 5.

FIG. 7B is a diagram showing an example of a distribution of the axial-direction flow speed of the fuel and the air in a case where the shape of the orifice 62 deviates from the design shape and the orifice 62 is formed to inject the fuel in a direction inclined from the central axis O for the mixing flow path 46 of the burner 42 shown in FIG. 5.

FIG. 8 is a view showing a distribution C1 of the axial-direction flow speed of the fuel at a position of an outlet 60 of a fuel nozzle 43 in FIG. 7A and a distribution C2 of the axial-direction flow speed of the fuel and the air at the position of the outlet 60 of the fuel nozzle 43 in the axial direction in FIG. 7B.

FIG. 9 is a diagram showing a relationship between L/D and a dimensionless wall surface fuel-air ratio at a position of a wall surface 63 of a flow path wall 55 in the vicinity of the outlet 49 of the mixing flow path 46 in a case where the shape of the orifice 62 deviates from the design shape and the orifice 62 is formed to inject the fuel in the direction inclined from the central axis O for the mixing flow path 46 of the burner 42 shown in FIG. 5.

### DESCRIPTION OF EMBODIMENTS

Hereinafter, some embodiments of the present disclosure will be described with reference to the accompanying drawings. However, dimensions, materials, shapes, relative dispositions, and the like of components described as embodiments or shown in the drawings are not intended to limit the scope of the invention, but are only explanatory examples.

For example, it is assumed that, strictly speaking, an expression representing relative or absolute disposition, such as “in a certain direction”, “along a certain direction”, “parallel”, “orthogonal”, “center”, “concentric”, or “coaxial”, not only represents the disposition, but also represents a state of relative displacement with a tolerance or a sufficient angle or distance to obtain the same function.

For example, it is assumed that, strictly speaking, expressions, such as “identical”, “equal”, and “homogeneous”, representing that things are in an equal state not only represent the equal state, but also represent a state in which there is a tolerance or a sufficient difference to obtain the same function.

For example, it is assumed that an expression representing a shape, such as a quadrangular shape or a cylindrical shape, not only represents a shape, such as a quadrangular shape or a cylindrical shape, in a geometrically strict sense, but also represents a shape including an uneven portion, a chamfered portion, or the like within a range in which the same effect is obtained.

Meanwhile, an expression “being provided with”, “being equipped with”, “comprising”, “including”, or “having” one component is not an exclusive expression that excludes the presence of other components.

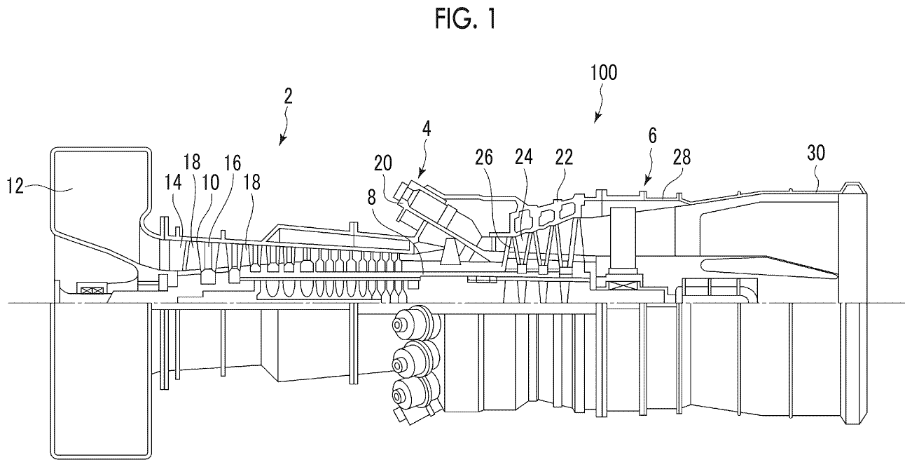

FIG. 1 is a schematic configuration diagram showing a gas turbine 100 according to an embodiment of the present disclosure. As shown in FIG. 1, a gas turbine 100 according to the embodiment includes a compressor 2 for compressing air as an oxygen containing gas to be supplied to a combustor 4 (that is, for generating compressed air), the combustor 4 (gas turbine combustor) for generating combustion gas using the compressed air and fuel, and a turbine 6 configured to be driven by the combustion gas discharged from the combustor 4. In the case of the gas turbine 100 for power generation, a generator (not shown) is connected to the turbine 6, and power is generated by rotational energy of the turbine 6.

In the combustor 4 of the gas turbine 100, a mixed gas of air and fuel is combusted to generate the combustion gas. Examples of the fuel to be combusted in the combustor 4 include hydrogen, methane, light oil, heavy oil, jet fuel, natural gas, and gasified coal, and one of the fuels or any combination of two or more of the fuels can be combusted.

The compressor 2 includes a compressor casing 10, an air intake port 12 that is provided on an inlet side of the compressor casing 10 to take in air, a rotor 8 that is provided to penetrate both the compressor casing 10 and a turbine casing 22, and various blades that are disposed within the compressor casing 10. The various blades include an inlet guide blade 14 provided on a side of the air intake port 12, a plurality of stator vanes 16 fixed to a side of the compressor casing 10, and a plurality of rotor blades 18 embedded in the rotor 8 to be alternately arranged with respect to the stator vanes 16. In the compressor 2, the air taken in from the air intake port 12 passes through the plurality of stator vanes 16 and the plurality of rotor blades 18 and is compressed to be high-temperature and high-pressure compressed air. Then, the high-temperature and high-pressure compressed air is sent from the compressor 2 to the combustor 4 in a rear stage.

A plurality of combustors 4 are disposed at intervals in the circumferential direction around the rotor 8. The combustor 4 is supplied with the fuel and the compressed air generated by the compressor 2 and combusts the fuel to generate combustion gas which is a working fluid of the turbine 6. Then, the combustion gas is sent from the combustor 4 to the turbine 6 in the rear stage.

The turbine 6 includes a turbine casing 22 and various blades that are disposed in the turbine casing 22. The various blades include a plurality of stator vanes 24 fixed to a side of the turbine casing 22 and a plurality of rotor blades 26 embedded in the rotor 8 to be alternately arranged with respect to the stator vanes 24. In the turbine 6, the combustion gas passes through the plurality of stator vanes 24 and the plurality of rotor blades 26 to rotationally drive the rotor 8. In this way, the generator (not shown) connected to the rotor 8 is driven.

In addition, an exhaust chamber 30 is connected to a downstream side of the turbine casing 22 through an exhaust casing 28. After the turbine 6 is driven, the combustion gas is discharged to an outside through the exhaust casing 28 and the exhaust chamber 30.

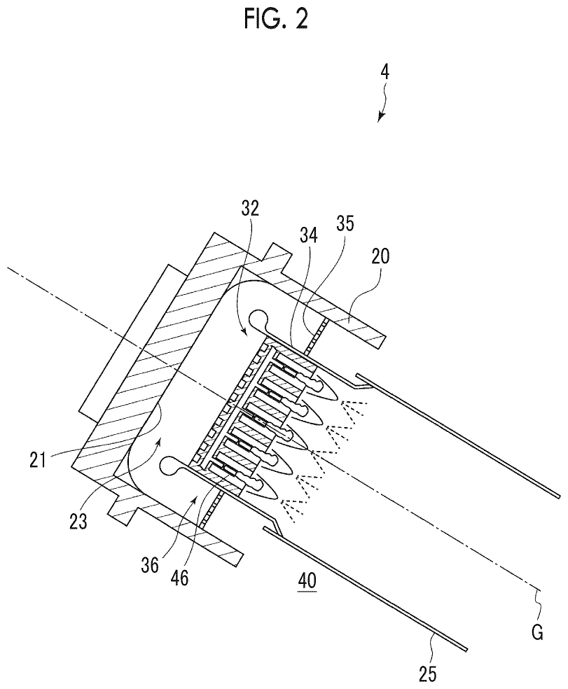

FIG. 2 is a schematic cross-sectional view showing the vicinity of the combustor 4. The combustor 4 includes a burner assembly 32, a casing 20 that has a bottomed tubular shape and accommodates the burner assembly 32, and a combustion cylinder 25 that forms a space, in which a flame is formed, on the downstream side of the burner assembly 32. In FIG. 2, a one-dot chain line is a central axis G that is common to the casing 20, the burner assembly 32, and the combustion cylinder 25. The burner assembly 32 is disposed inside the casing 20 of the combustor 4.

In the exemplary embodiment shown in the drawings, the burner assembly 32 is held inside a tubular member 34 disposed inside the casing 20, and the tubular member 34 is supported by the casing 20 through a plurality of support portions 35 disposed at intervals around the central axis G. An air flow path 36 through which the compressed air flowing from a casing 40 flows is formed between the casing 20 and an outer peripheral surface of the tubular member 34 (between the casing 20 and an outer peripheral surface of the burner assembly 32).

The compressed air that has flowed from the casing 40 into the air flow path 36 flows into a plurality of mixing flow paths 46, which will be described below, provided in the burner assembly 32 together with the fuel through a gap 23 between the burner assembly 32 and a bottom surface 21 of the casing 20 in an axial direction. The fuel and the air mixed in the burner assembly 32 are ignited by an ignition device (not shown), and a flame is formed in the combustion cylinder 25 to generate combustion gas.

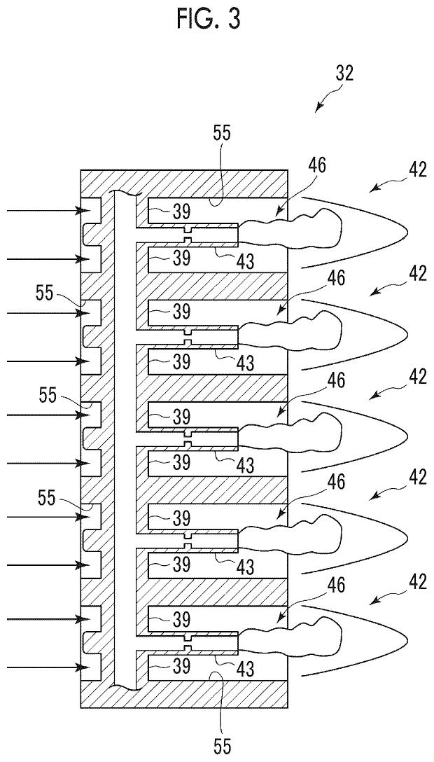

FIG. 3 is a schematic cross-sectional view taken along the central axis G of the burner assembly 32 according to the embodiment.

As shown in FIG. 3, the burner assembly 32 includes a plurality of burners 42 for mixing fuel and air.

Each of the plurality of burners 42 includes a fuel nozzle 43 for injecting fuel, a mixing flow path 46 (mixing pipe) to which fuel and air are supplied, and a plurality of support portions 39 that connect a flow path wall 55 of the mixing flow path 46 (an inner peripheral surface of the mixing flow path 46) and the fuel nozzle 43 and support the fuel nozzle 43. Since the plurality of burners 42 have basically the same configuration except for a portion forming the outer peripheral surface of the burner assembly 32, hereinafter, a configuration common to the burners 42 will be described.

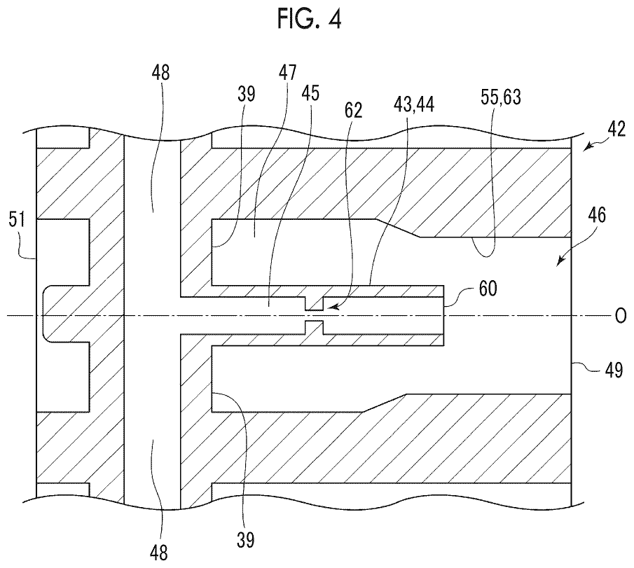

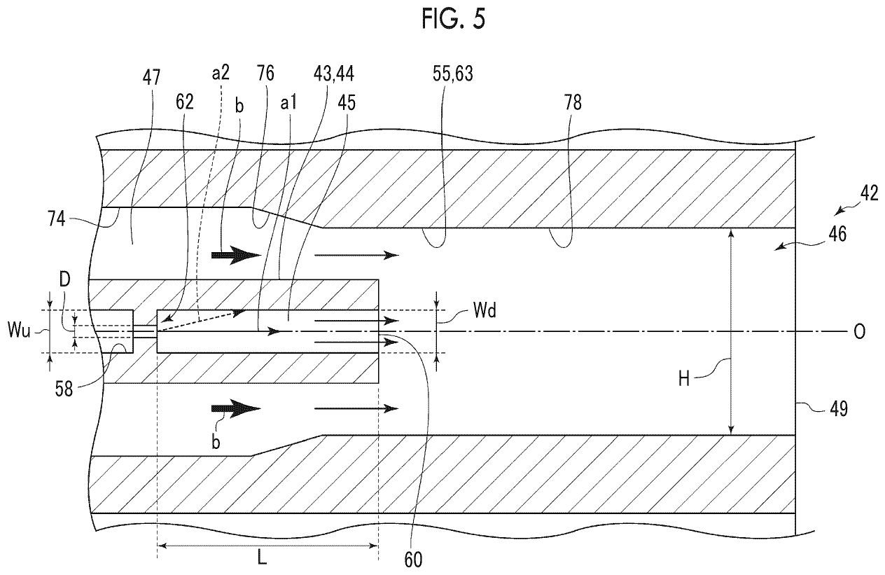

FIG. 4 is a schematic cross-sectional view showing an example of a schematic configuration of the burner 42. FIG. 5 is an enlarged schematic cross-sectional view showing the vicinity of an outlet 49 of the mixing flow path 46 shown in FIG. 4.

For example, as shown in FIG. 4, the fuel nozzle 43 is formed in a tubular shape and extends along the central axis O of the mixing flow path 46 inside the mixing flow path 46. A fuel channel 45 is formed on the central axis O inside the fuel nozzle 43. An outlet 60 of the fuel nozzle 43 (an outlet of the fuel channel 45) is formed at a tip of the fuel nozzle 43. In addition, the fuel nozzle 43 includes an orifice 62 that is provided on the upstream side of the outlet 60 of the fuel nozzle 43 in the fuel channel 45. The orifice 62 of the fuel nozzle 43 is located on the central axis O and is configured to inject the fuel along the central axis O as represented by an arrow al in FIG. 5. In the following description, unless otherwise specified, the term “axial direction” means a direction parallel to the central axis O, that is, an axial direction of the fuel nozzle 43 (an axial direction of the mixing flow path 46).

For example, as shown in FIG. 4, the mixing flow path 46 is formed in a tubular shape and extends along the central axis O. An air flow path 47 is formed on the outer peripheral side of the fuel nozzle 43 in the mixing flow path 46, that is, between the flow path wall 55 of the mixing flow path 46 and an outer peripheral surface 44 of the fuel nozzle 43, and the compressed air that has flowed into the mixing flow path 46 from the inlet 51 of the mixing flow path 46 passes through the air flow path 47 as represented by an arrow b in FIG. 5 and then is mixed with the fuel injected from the outlet 60 of the fuel nozzle 43.

For example, as shown in FIG. 4, a fuel channel 48 for supplying fuel to the fuel nozzle 43 is formed inside the support portion 39 and inside the flow path wall 55. The fuel channel 48 is connected to the fuel channel 45 of the fuel nozzle 43. The fuel supplied from a fuel supply source (not shown) to the burner assembly 32 is supplied to the fuel channel 45 of the fuel nozzle 43 through the fuel channel 48 (that is, through the inside of the flow path wall 55 and the inside of the support portion 39) and is injected from the outlet 60 of the fuel nozzle 43 to the mixing flow path 46 through the fuel channel 45 of the fuel nozzle 43.

For example, as shown in FIG. 5, the orifice 62 is configured as an annular protrusion portion that protrudes from a flow path wall 58 of the fuel channel 45 toward the central axis O. In addition, when an orifice diameter of the orifice 62 is D, a flow path width of the fuel channel 45 on the downstream side of the orifice 62 in the fuel channel 45 is Wd, and a flow path width of the fuel channel 45 on the upstream side of the orifice 62 in the fuel channel 45 is Wu, Wd>D and Wu>D are satisfied. Further, typically, the shape of a flow path cross section of the fuel channel 45 and the shape of a flow path cross section of the orifice 62 are circular. In this case, the orifice diameter D is the diameter of the orifice 62, and the flow path widths Wu and Wd of the fuel channel 45 are the diameters of the fuel channel 45. In addition, in the exemplary embodiment shown in the drawings, each of the flow path widths Wu and Wd of the fuel channel 45 is constant regardless of the position in the axial direction. In addition, the flow path wall 55 of the mixing flow path 46 includes constant flow path width portions 74 and 78 and a narrowed portion 76. A flow path width H of each of the constant flow path width portion 74 and the constant flow path width portion 78 is constant regardless of the position in the axial direction. The flow path width H of the narrowed portion 76 is smaller toward the downstream side. In the exemplary embodiment shown in the drawings, the constant flow path width portion 74, the narrowed portion 76, and the constant flow path width portion 78 are provided in order from the upstream side of the mixing flow path 46, and the narrowed portion 76 is located on the upstream side of the outlet 60 of the fuel nozzle 43 in the axial direction.

According to the burner assembly 32, as shown in FIG. 4 and the like, in each of the burners 42, the fuel nozzle 43 is supported by the support portion 39 that is connected to a wall surface 63 of the flow path wall 55 of the mixing flow path 46. Therefore, it is not necessary to provide the large header described in PTL 1 that is configured independently of the flow path wall 55 of the mixing flow path 46 on the upstream side of the mixing flow path 46. Therefore, it is possible to eliminate a bias in the flow rate of air between a plurality of mixing flow paths caused by the header and to reduce a bias in the concentration of the fuel between the plurality of mixing flow paths 46. Therefore, it is possible to reduce NOx and to suppress flashback.

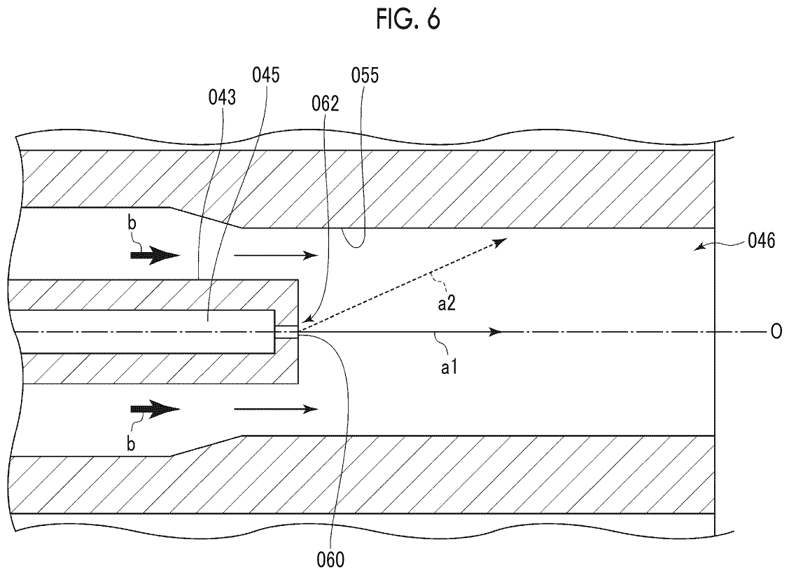

Next, the technical significance of the configuration in which the orifice 62 of the fuel nozzle 43 is provided on the upstream side of the outlet 60 of the fuel nozzle 43 will be described based on a comparison with a comparative example. FIG. 6 is a schematic cross-sectional view showing the vicinity of an outlet 060 of a fuel nozzle 043 in a mixing flow path 046 according to the comparative example.

The fuel nozzle 043 according to the comparative example shown in FIG. 6 has an orifice 062 that is provided at the position of the outlet 060 of the fuel nozzle 043. That is, the flow path width of a fuel channel 045 of the fuel nozzle 043 according to the comparative example is minimum at the position of the outlet 060 of the fuel nozzle 043. In the case of this configuration, when the shape, dimensions, and the like of the orifice 062 deviate from the design point at the time of the manufacture of the burner assembly (for example, when the orifice 062 is formed to inject fuel in a direction inclined from the central axis O as represented by an arrow a2 in FIG. 6), the fuel is injected from the orifice 062 of the fuel nozzle 043 (the outlet 060 of the fuel nozzle 043) toward a flow path wall 055 of the mixing flow path 046. Therefore, the concentration of the fuel in the vicinity of the flow path wall 055 of the mixing flow path 046 is locally increased, and the risk of flashback occurring is increased.

In contrast, in the embodiment shown in FIGS. 4 and 5, even when the shape, dimensions, and the like of the orifice 62 deviate from the design point at the time of the manufacture of the burner assembly 32 (for example, when the orifice 62 is formed to inject fuel in a direction inclined from the central axis O as represented by an arrow a2 in FIG. 5), the fuel injected from the orifice 62 is rectified by the fuel channel 45 inside the fuel nozzle 43 before reaching the outlet 60 of the fuel nozzle 43 since the orifice 62 of the fuel nozzle 43 is located on the upstream side of the outlet 60 of the fuel nozzle 43. Therefore, it is possible to suppress the flow distortion of the fuel at the position of the outlet 60 of the fuel nozzle 43. As a result, it is possible to suppress the diffusion of the fuel, which has been injected from the outlet 60 of the fuel nozzle 43, to the flow path wall 55 of the mixing flow path 46 and to reduce the risk of flashback occurring.

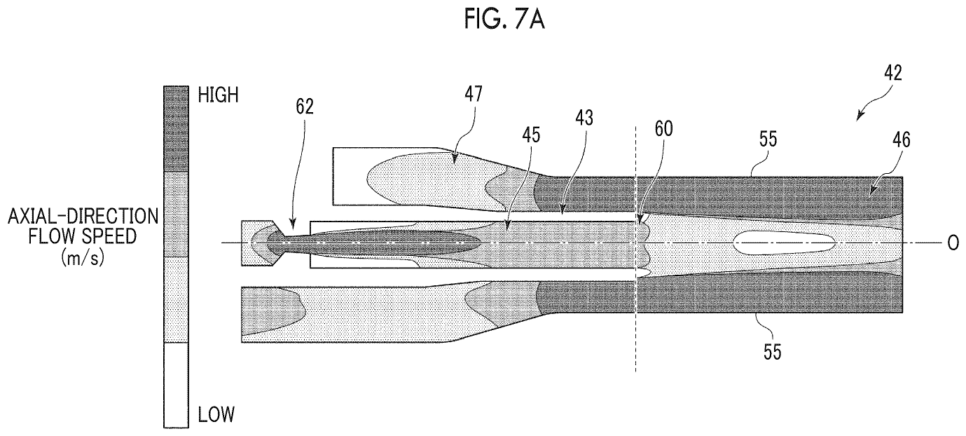

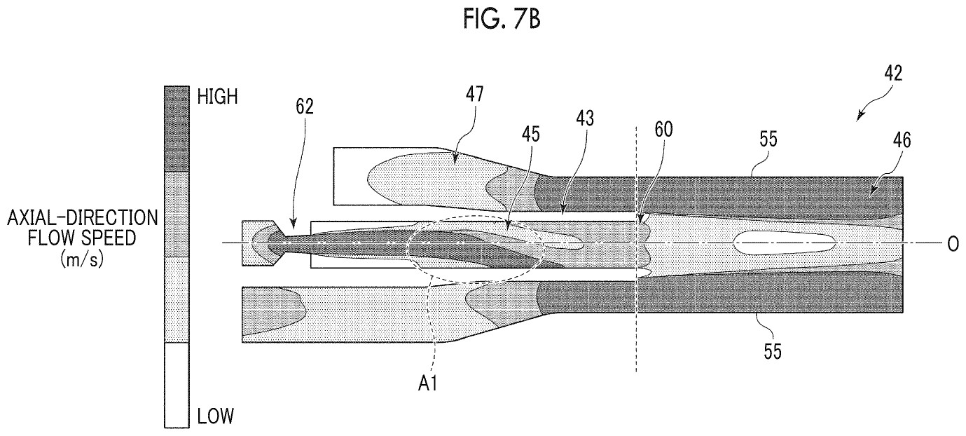

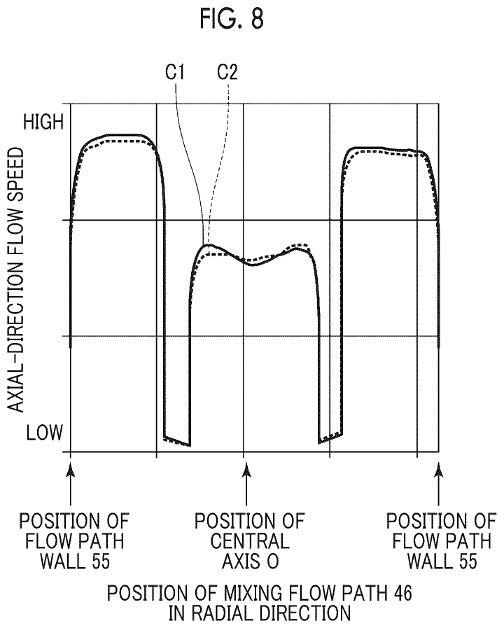

FIG. 7A is a diagram showing an example of a distribution of an axial-direction flow speed of fuel and air in a case where the orifice 62 is formed as designed to inject the fuel along the central axis O for the mixing flow path 46 of the burner 42. FIG. 7B is a diagram showing an example of a distribution of an axial-direction flow speed of fuel and air in a case where the shape of the orifice 62 deviates from the design shape and the orifice 62 is formed to inject the fuel in a direction inclined from the central axis O for the mixing flow path 46 of the burner 42. FIG. 8 is a diagram showing a distribution C1 of the axial-direction flow speed of fuel and air at the position of the outlet 60 of the fuel nozzle 43 in the axial direction in FIG. 7A and a distribution C2 of the axial-direction flow speed of fuel and air at the position of the outlet 60 of the fuel nozzle 43 in the axial direction in FIG. 7B.

When FIGS. 7A and 7B are compared, in FIG. 7A, the axial-direction flow speed of the fuel has a distribution that is approximately symmetrical with respect to the central axis O. In contrast, in FIG. 7B, in a region Al indicating a jet flow of the fuel immediately after being injected from the orifice 62, the axial-direction flow speed of the fuel on the lower side of the central axis O is higher than that on the upper side thereof, and the jet flow of the fuel is biased with respect to the central axis O. However, since the orifice 62 is provided on the upstream side of the outlet 60 of the nozzle 43, the fuel injected from the orifice 62 is rectified by the fuel channel 45 inside the fuel nozzle 43 before reaching the outlet 60 of the fuel nozzle 43, and the axial-direction flow speed of the fuel at the position of the outlet 60 of the nozzle 43 has a distribution that is approximately symmetrical with respect to the central axis O. Therefore, as shown in FIG. 8, the distribution C1 and the distribution C2 are substantially the same distribution. As described above, according to the burner assembly 32, even in a case where the shape of the orifice 62 deviates from the design shape and the orifice 62 is formed to inject the fuel in the direction inclined from the central axis O, it is possible to suppress the flow distortion of the fuel at the position of the outlet 60 of the fuel nozzle 43. Therefore, it is possible to suppress the diffusion of the fuel, which has been injected from the outlet 60 of the fuel nozzle 43, to the flow path wall 55 of the mixing flow path 46 and to reduce the risk of flashback occurring.

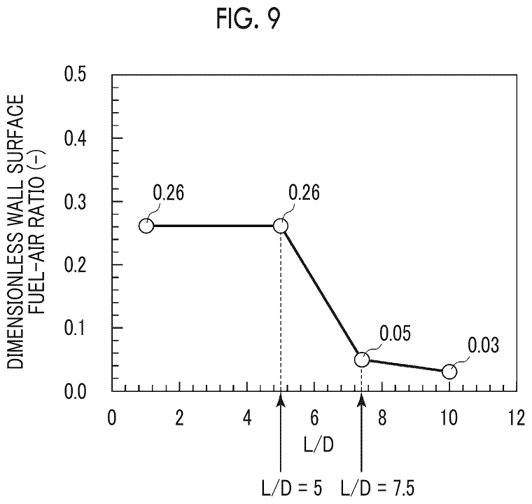

In some embodiments, for example, as shown in FIG. 5, when the distance between the outlet 60 and the orifice 62 in the fuel nozzle 43 is L and the orifice diameter of the orifice 62 is D, the fuel nozzle 43 may satisfy L/D>5 and more desirably satisfy L/D≥7.5. That is, a value obtained by dividing the distance L between the outlet 60 and the orifice 62 in the fuel nozzle 43 by the orifice diameter D of the orifice 62 may be greater than 5 and more desirably equal to or greater than 7.5. Hereinafter, the technical significance of satisfying L/D>5 and the technical significance of satisfying L/D≥7.5 will be described with reference to FIG. 9.

FIG. 9 is a diagram showing a relationship between the L/D and a dimensionless wall surface fuel-air ratio at the position of the wall surface 63 of the flow path wall 55 in the vicinity of the outlet 49 of the mixing flow path 46 in a case where the shape of the orifice 62 deviates from the design shape and the orifice 62 is formed to inject the fuel in a direction b (see FIG. 5) inclined from the central axis O for the mixing flow path 46 of the burner 42. In addition, the fuel-air ratio is the reciprocal of an air-fuel ratio and is a dimensionless quantity obtained by dividing the fuel mass by the air mass, and the dimensionless wall surface fuel-air ratio is a dimensionless quantity calculated by dividing the fuel-air ratio at the position of the wall surface 63 by the average fuel-air ratio of the entire cross section of the flow path including the position.

As shown in FIG. 9, in a range satisfying L/D≤5, the dimensionless wall surface fuel-air ratio at the position of the wall surface 63 of the flow path wall 55 in the vicinity of the outlet 49 of the mixing flow path 46 is approximately constant regardless of the value of L/D. On the other hand, in a range satisfying L/D>5, the dimensionless wall surface fuel-air ratio decreases as L/D increases. In addition, in a range satisfying L/D≥7.5, the dimensionless wall surface fuel-air ratio at the position of the wall surface 63 of the flow path wall 55 in the vicinity of the outlet 49 of the mixing flow path 46 is significantly and greatly smaller than that in the range satisfying L/D≤5.

Therefore, even in a case where the shape, dimensions, and the like of the orifice 62 deviate from the design point when the burner assembly 32 is manufactured, L/D>5 is satisfied. Therefore, the fuel injected from the orifice 62 is rectified inside the fuel nozzle 43 before reaching the outlet 60 of the fuel nozzle 43. As a result, it is possible to suppress the flow distortion of the fuel at the position of the outlet 60 of the fuel nozzle 43 and to suppress an increase in the fuel-air ratio on the wall surface 63 of the flow path wall 55 in the vicinity of the outlet 49 of the mixing flow path 46. In addition, since L/D≥7.5 is satisfied, the fuel injected from the orifice 62 is well rectified inside the fuel nozzle 43 before reaching the outlet 60 of the fuel nozzle 43. Therefore, it is possible to significantly suppress the flow distortion of the fuel at the position of the outlet 60 of the fuel nozzle 43 and to significantly and greatly suppress an increase in the fuel-air ratio on the wall surface 63 of the flow path wall 55 in the vicinity of the outlet 49 of the mixing flow path 46. As a result, it is possible to effectively reduce the risk of flashback occurring. Further, in a case where L/D>5 or L/D>7.5 is satisfied, L/Wd<25 may be further satisfied in order to suppress a decrease in the flow speed on the inner wall surface side of the fuel nozzle 43 due to the complete development of the in-tube flow of the fuel nozzle 43.

In some embodiments, for example, in the configuration shown in FIGS. 4 and 5, when a flow path area of the outlet 60 of the fuel nozzle 43 is Af and a flow path area of the air flow path 47 at the position of the outlet 60 in the axial direction is Aa, the ratio of the flow path area Af to the flow path area Aa may satisfy Af/Aa≥0.1.

In this configuration, Af/Aa is significantly larger than that in the burner assembly according to the related art, and the flow speed of the fuel at the position of the outlet 60 of the fuel nozzle 43 in the axial direction is actively lower than the flow speed of the air. Therefore, the flow distortion of the fuel remaining at the outlet 60 of the fuel nozzle 43 can be well rectified by the air in the air flow path 47, and it is possible to suppress the arrival of the fuel injected from the fuel nozzle 43 at the flow path wall 55 of the mixing flow path 46. As a result, it is possible to suppress an increase in the fuel-air ratio on the wall surface 63 of the flow path wall 55 in the vicinity of the outlet 49 of the mixing flow path 46 and thus to effectively reduce the risk of flashback occurring. Further, in a case where Af/Aa≥0.1 is satisfied, Af/Aa<0.65 may be further satisfied from the viewpoint of suppressing an increase in the pressure loss of the air flow path 47.

In some embodiments, when the density of the fuel at the outlet 60 of the fuel nozzle 43 is ρf, the flow speed of the fuel at the outlet 60 of the fuel nozzle 43 is Vf, the density of the air in the air flow path 47 at the position of the outlet 60 of the fuel nozzle 43 in the axial direction is ρa, and the flow speed of the air in the air flow path 47 at the position of the outlet 60 of the fuel nozzle 43 in the axial direction is Va at the time of the rated operation of the gas turbine, ρf×(Vf)²<ρa×(Va)² may be satisfied. That is, at the time of the rated operation of the gas turbine, the momentum of the air in the air flow path 47 at the position of the outlet 60 of the fuel nozzle 43 in the axial direction may be larger than the momentum of the fuel at the outlet 60 of the fuel nozzle 43.

In this configuration, the flow distortion of the fuel remaining in the outlet 60 of the fuel nozzle 43 can be well rectified by the air in the air flow path 47, and it is possible to suppress the arrival of the fuel injected from the fuel nozzle 43 at the flow path wall 55 of the mixing flow path 46. Therefore, it is possible to suppress an increase in the fuel-air ratio on the wall surface 63 of the flow path wall 55 in the vicinity of the outlet 49 of the mixing flow path 46 and thus to effectively reduce the risk of flashback occurring.

The present disclosure is not limited to the above-described embodiments and also includes modifications of the above-described embodiments and appropriate combinations of the modifications.

For example, in the exemplary embodiment shown in FIG. 5, the flow path wall 55 of the mixing flow path 46 has the narrowed portion 76 on the upstream side of the outlet 60 of the fuel nozzle 43. However, the flow path wall 55 of the mixing flow path 46 may not have the narrowed portion 76, and the flow path width of the mixing flow path 46 may be constant from the inlet 51 to the outlet 49 of the mixing flow path 46.

The flow path width of the fuel channel 45 formed inside the fuel nozzle 43 shown in FIG. 5 and the like is constant on the downstream side of the orifice 62 regardless of the position in the axial direction. However, the fuel channel 45 may have a section, in which the flow path width of the fuel channel 45 increases toward the downstream side, on the downstream side of the orifice 62.

For example, the content described in each of the embodiments is understood as follows.

(1) A burner assembly (for example, the burner assembly 32) according to at least one embodiment of the present disclosure includes:

a plurality of burners (for example, the burners 42) for mixing fuel and air,

in which each of the plurality of burners includes

a mixing flow path (for example, the mixing flow path 46) to which the air is supplied, and

a fuel nozzle (for example, the fuel nozzle 43) that extends along a central axis of the mixing flow path inside the mixing flow path and is configured to inject the fuel, and

the fuel nozzle includes an orifice (for example, the orifice 62) provided on an upstream side of an outlet of the fuel nozzle.

According to the burner assembly of (1), even in a case where the shape, dimensions, and the like of the orifice deviate from the design point when the burner assembly is manufactured, the fuel injected from the orifice is rectified inside the fuel nozzle before reaching the outlet of the fuel nozzle since the orifice of the fuel nozzle is located on the upstream side of the outlet of the fuel nozzle. Therefore, it is possible to suppress the flow distortion of the fuel at the position of the outlet of the fuel nozzle. As a result, it is possible to suppress the diffusion of the fuel, which has been injected from the outlet of the fuel nozzle, to the flow path wall of the mixing flow path and to reduce the risk of flashback occurring.

(2) In some embodiments, in the burner assembly according to (1),

when a distance between the outlet and the orifice in the fuel nozzle is L and an orifice diameter of the orifice is D, L/D>5 is satisfied.

According to the burner assembly of (2), even in a case where the shape, dimensions, and the like of the orifice deviate from the design point when the burner assembly is manufactured, L/D>5 is satisfied. Therefore, the fuel injected from the orifice is rectified to some extent inside the fuel nozzle before reaching the outlet of the fuel nozzle, and thus it is possible to suppress the flow distortion of the fuel at the position of the outlet of the fuel nozzle. As a result, it is possible to suppress an increase in the fuel-air ratio on the wall surface of the flow path wall of the mixing flow path and thus to reduce the risk of flashback occurring.

(3) In some embodiments, in the burner assembly according to (1) or (2), L/D≥7.5 is satisfied.

According to the burner assembly of (3), even in a case where the shape, dimensions, and the like of the orifice deviate from the design point when the burner assembly is manufactured, L/D≥7.5 is satisfied. Therefore, the fuel injected from the orifice is well rectified inside the fuel nozzle before reaching the outlet of the fuel nozzle, and thus it is possible to significantly suppress the flow distortion of the fuel at the position of the outlet of the fuel nozzle. As a result, it is possible to significantly and greatly suppress an increase in the fuel-air ratio on the wall surface of the flow path wall of the mixing flow path and thus to effectively reduce the risk of flashback occurring.

(4) In some embodiments, in the burner assembly according to any one of (1) to (3),

the mixing flow path includes an air flow path (for example, the air flow path 47) provided on an outer peripheral side of the fuel nozzle, and

when a flow path area of the outlet of the fuel nozzle is Af and a flow path area of the air flow path at a position of the outlet of the fuel nozzle in an axial direction is Aa, Af/Aa≥0.1 is satisfied.

According to the burner assembly of (4), Af/Aa is significantly larger than that in the burner assembly according to the related art, and the flow speed of the fuel at the position of the outlet of the fuel nozzle in the axial direction is actively lower than the flow speed of the air. Therefore, the flow distortion of the fuel remaining at the outlet of the fuel nozzle can be well rectified by the air of the air flow path, and it is possible to suppress the arrival of the fuel injected from the fuel nozzle at the flow path wall of the mixing flow path. As a result, it is possible to suppress an increase in the fuel-air ratio on the wall surface of the flow path wall in the vicinity of the outlet of the mixing flow path and thus to effectively reduce the risk of flashback occurring.

(5) A gas turbine combustor (for example, the combustor 4) according to at least one embodiment of the present disclosure includes:

the burner assembly according to any one of (1) to (4); and

a combustion cylinder (for example, the combustion cylinder 25) that forms a space, in which a flame is formed, on a downstream side of the burner assembly.

According to the burner assembly of (5), since the gas turbine combustor includes the burner assembly according to any one of (1) to (4), it is possible to reduce the risk of flashback occurring.

(6) A gas turbine (for example, the gas turbine 100) according to at least one embodiment of the present disclosure includes:

a compressor (for example, the compressor 2);

a gas turbine combustor (for example, the combustor 4) that is configured to be supplied with air compressed by the compressor and fuel and to combust the fuel to generate a combustion gas; and

a turbine (for example, the turbine 6) that is driven by the combustion gas generated by the gas turbine combustor,

in which the gas turbine combustor is the gas turbine combustor according to (5).

According to the burner assembly of (6), since the gas turbine includes the gas turbine combustor according to (5), it is possible to reduce the risk of flashback occurring.

(7) In some embodiments, in the gas turbine according to (6),

the mixing flow path includes an air flow path (for example, the air flow path 47) provided on an outer peripheral side of the fuel nozzle, and

when a density of the fuel at the outlet of the fuel nozzle is ρf, a flow speed of the fuel at the outlet of the fuel nozzle is Vf, a density of the air in the air flow path at a position of the outlet of the fuel nozzle in an axial direction of the fuel nozzle is ρa, and a flow speed of the air in the air flow path at the position of the outlet of the fuel nozzle in the axial direction of the fuel nozzle is Va at a time of a rated operation of the gas turbine, ρf×(Vf)²<ρa×(Va)² is satisfied.

According to the gas turbine of (7), the momentum (ρa×(Va)²) of the air at the position of the outlet of the fuel nozzle in the axial direction is larger than the momentum (ρf×(Vf)²) of the fuel at the outlet of the fuel nozzle. Therefore, the flow distortion of the fuel remaining in the outlet of the fuel nozzle can be rectified by the air in the air flow path and it is possible to suppress the arrival of the flow distortion remaining in the outlet of the fuel nozzle at the flow path wall of the mixing flow path. Therefore, it is possible to effectively reduce the risk of flashback occurring.

Reference Signs List 2: Compressor 4: Combustor
6: Turbine
8: Rotor
10: Compressor casing
12, 51: Inlet
14: Inlet guide blade
16, 24: Stator vane
18, 26: Rotor blade
20: Casing
21: Bottom surface
22: Turbine casing
23: Gap
25: Combustion cylinder
28: Exhaust casing
30: Exhaust chamber
32: Burner assembly
34: Tubular member
35, 39: Support portion
36, 47: Air flow path
49, 60: Outlet
40: Casing
42: Burner
43: Fuel nozzle
44: Outer peripheral surface
45, 48: Fuel channel
46: Mixing flow path
55, 58: Flow path wall
62: Orifice
63: Wall surface
74, 78: Constant flow path width portion
76: Narrowed portion
100: Gas turbine

1. A burner assembly comprising:
a plurality of burners for mixing fuel and air,
wherein each of the plurality of burners includes
a mixing flow path to which the air is supplied, and
a fuel nozzle that extends along a central axis of the mixing flow path inside the mixing flow path and is configured to inject the fuel, and
the fuel nozzle is formed in a tubular shape and includes an orifice provided on an upstream side of an outlet at a tip of the fuel nozzle.

2. The burner assembly according to claim 1,
wherein, when a distance between the outlet and the orifice in the fuel nozzle is L and an orifice diameter of the orifice is D, L/D>5 is satisfied.

3. The burner assembly according to claim 2,
wherein L/D≥7.5 is satisfied.

4. The burner assembly according to claim 1,
wherein the mixing flow path includes an air flow path provided on an outer peripheral side of the fuel nozzle, and
when a flow path area of the outlet of the fuel nozzle is Af and a flow path area of the air flow path at a position of the outlet of the fuel nozzle in an axial direction is Aa, Af/Aa≥0.1 is satisfied.

5. A gas turbine combustor comprising:
the burner assembly according to claim 1; and
a combustion cylinder that forms a space, in which a flame is formed, on a downstream side of the burner assembly.

6. A gas turbine comprising:
a compressor;
a gas turbine combustor that is configured to be supplied with air compressed by the compressor and fuel and to combust the fuel to generate a combustion gas; and
a turbine that is driven by the combustion gas generated by the gas turbine combustor, wherein the gas turbine combustor is the gas turbine combustor according to claim 5.

7. The gas turbine according to claim 6,
wherein the mixing flow path includes an air flow path provided on an outer peripheral side of the fuel nozzle, and
when a density of the fuel at the outlet of the fuel nozzle is ρf, a flow speed of the fuel at the outlet of the fuel nozzle is Vf, a density of the air in the air flow path at a position of the outlet of the fuel nozzle in an axial direction of the fuel nozzle is ρa, and a flow speed of the air in the air flow path at the position of the outlet of the fuel nozzle in the axial direction of the fuel nozzle is Va at a time of a rated operation of the gas turbine, ρf×(Vf)²<ρa×(Va)² is satisfied.
